(19) United States
(12) Patent Application Publication
(10) Pub. No.: US 2013/0175219 A1
(43) Pub. Date: Jul. 11, 2013

(54) WETTING OF A PLASTIC BED SUPPORT FOR A CHROMATOGRAPHY COLUMN

(71) Applicants: Lena Anderstedt, Uppsala (SE); Johan F. Avallin, Uppsala (SE); Jonas Karlsson, Uppsala (SE)

(72) Inventors: Lena Anderstedt, Uppsala (SE); Johan F. Avallin, Uppsala (SE); Jonas Karlsson, Uppsala (SE)

(73) Assignee: GE Healthcare Bio-Sciences AB, Uppsala (SE)

(21) Appl. No.: 13/825,905

(22) PCT Filed: Sep. 21, 2011
(86) PCT No.: PCT/SE11/51132

§ 371 Date: Mar. 25, 2013

(30) Foreign Application Priority Data
Sep. 24, 2010 (SE) 1050993-3

(51) Int. Cl. B01D 15/10

(52) U.S. Cl. CPC B01D 15/10
USPC 210/656

(57) ABSTRACT

A method for wetting a plastic bed support for a chromatography column, comprising the steps of providing a plastic bed support with a pore structure comprising air in said pore structure and soaking the plastic bed support in an aqueous solution comprising 0.1-30 wt % of a non-surfactant wetting agent, resulting in the removal of at least about 60% of the air from said pore structure.

### TECHNICAL FIELD

The present invention relates generally to separation and specifically to process chromatography. More particularly it relates to wetting of bed supports for chromatography columns.

### BACKGROUND OF THE INVENTION

Chromatography columns may be used in industrial processes to purify process liquids and separate substances of interest from process liquids. One important application is in bioprocessing, where proteins and other biopharmaceuticals are purified from complex biological feedstocks. Typical chromatography columns comprise a column wall in the form of hollow column tube which is connected to a removable upper end plate assembly and a removable lower end plate assembly. One end plate assembly is provided with a process fluid inlet arrangement, typically comprising an inlet pipe and an inlet valve and the other end plate assembly is provided with a process fluid outlet arrangement, typically comprising an outlet pipe and an outlet valve. Each end of the column tube is usually provided with a removable distributor plate in the interior of the column. These inlet and outlet distributor plates may be attached to the respective end plate assembly or the upper distributor plate may be arranged to be movable towards or away from the end plate assembly. During use, the space in the column between the distributor plates is usually filled with a chromatography medium. A porous bed support is normally provided between each distribution system and the media in order to prevent media particles from escaping the column. The inlet distributor plate is intended to distribute incoming fluid evenly over the surface of the media at the inlet end of the column while the outlet distributor plate is intended to collect fluid evenly from the surface of the media at the outlet end of the column. Such a column may weigh several tons.

The porous bed supports extend across substantially the whole internal diameter of the column and are normally fixed along the outer perimeter of the column and at the center of the column. The supports can be prepared from woven threads of either metals or polymers or they can be made from sintered particles. They can also be multilayer constructions of e.g. several woven meshes joined by sintering. In the processing of biomolecules it is common to use corrosive liquids, such as solutions with high concentrations of chlorides, acidic buffers, hypochlorite etc and in these cases it is often preferred to use plastic bed supports to eliminate corrosion of stainless steels etc. A commonly used type of plastic bed support comprises porous frits prepared from sintered polymer particles. These frits are available in several materials, such as polyethylene, polypropylene etc from companies like Porvair PLC (UK) and Porex Corp (US).

These materials are hydrophobic and when they are to be used in the column after dry storage, they must be thoroughly wetted to displace the air from the pore structure. One way to do this is to immerse the bed support in a liquid having low surface tension, such as a water-miscible solvent or an aqueous surfactant solution and, once the air has been replaced, wash with water or an aqueous solution to be used in the operation of the column. I Bemberis et al (BioPharm International Guide pp 23-30, July 2003) recommend immersion of bed supports in >80% ethanol, isopropanol or methanol.

A drawback of the solvent method is that solvents are flammable and may only be handled in explosion classified locations where all electrical equipment is explosion proof. Since solvents are not normally handled in most bioprocessing facilities this involves substantial extra costs. Solvents may also attack materials in bioprocessing columns designed primarily for use with aqueous systems. An issue with surfactants is that they cause foaming and that they adsorb strongly to the pore surfaces, causing potential slow desorption and resulting leakage of surfactant traces into the biopharmaceutical product. Surfactants are non-desirable contaminants in parenteral pharmaceuticals, as they are irritants and disrupt cell membranes.

Hence, there is a need for a wetting method which involves neither flammable liquids nor surfactants.

### BRIEF DESCRIPTION OF THE INVENTION

One aspect of the present invention is to provide efficient chromatography in a column equipped with a plastic bed support, where the bed support is free from air. This is achieved with a wetting method as defined in claim 1 and with a chromatography method as defined in claim 13.

One advantage with such a method is that no surfactants or flammable solutions have to be used.

One or more of the aspects above may be achieved by the present invention as defined by the appended claims. Additional aspects, details and advantages of the invention will appear from the detailed description and claims that follow.

### BRIEF DESCRIPTION OF THE DRAWINGS

FIG. 1 shows a chromatography column with bed supports.

FIG. 2 shows a method for wetting a plastic bed support according to the invention.

FIG. 3 shows a method for wetting a plastic bed support according to the invention.

FIG. 4 shows a method for performing chromatography according to the invention

### DEFINITIONS

The term “non-surfactant wetting agent” means herein a wetting agent for the plastic bed support, which is not a surfactant. A surfactant (as defined e.g. in Kirk-Othmer Encyclopedia of Chemical Technology vol. 24, http://onlinelibrary.wiley.com/doi/10.1002/0471238961.1921180612251414.a01.pub2/abstract) is a species comprising a C8-C18 hydrocarbon or fluorocarbon chain and a hydrophilic group (polar or ionic). Hence, a surfactant has a molecular weight above 130 D. A wetting agent is an additive that increases the spreading and penetrating power of an aqueous liquid on a solid substrate. Examples of non-surfactant wetting agents are water soluble solvents and alkali metal hydroxides.

The term “flash point” means herein the lowest temperature at which a volatile liquid can vaporize to form an ignitable mixture in air. The flash point can be measured e.g. by the ASTM D3828 or ASTM D93 closed-cup methods and is an indication of the flammability of the liquid.

The term “water soluble” herein means that a substance is soluble in water at room temperature, i.e. about 25° C., to a concentration of at least 2 wt. %.

The term “water miscible” herein means that a substance is soluble in water at room temperature, i.e. about 25° C., over the entire 0-100% concentration range.

### DETAILED DESCRIPTION OF THE INVENTION

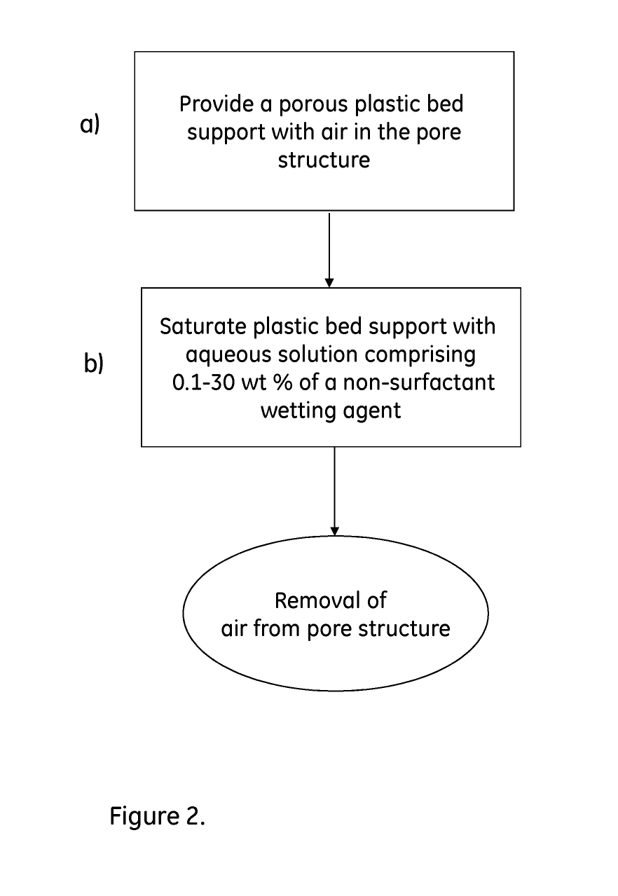

One aspect of the present invention, illustrated by FIG. 2, relates to providing efficient air removal from a plastic bed support without using surfactants or flammable solutions. This is achieved with a method where a porous plastic bed support having air in the pore structure is provided, the plastic bed support is soaked in an aqueous solution comprising 0.1-30 wt % of a non-surfactant wetting agent, resulting in the removal of at least about 60% of the air from the pore structure. The concentration of non-surfactant wetting agent in the aqueous solution can advantageously be 0.1-20 wt %, such as 0.1-17 wt % or 12-17 wt %. The method can also result in the removal of at least about 80%, such as at least about 90% of the air or substantially all air from the pore structure. It is to be understood that the air in the pore structure may comprise any gaseous materials e.g. originating from the manufacture or storage of the porous plastic bed support. The removal of the air can be checked e.g. by weighing the soaked bed support—complete air removal is indicated by a weight increase corresponding to the entire pore volume being filled. The pore volume is usually provided by the material supplier, but can also be measured either by porosimetric or densitometric methods known in the art. An alternative method to monitor the air removal can be by measuring the chromatographic performance of a column comprising the treated bed support—removal of substantially all air is here indicated by reaching the theoretically accessible plate number for the given packing material and column construction, as well as by a stable plate number when performing repeated packings of media in the column.

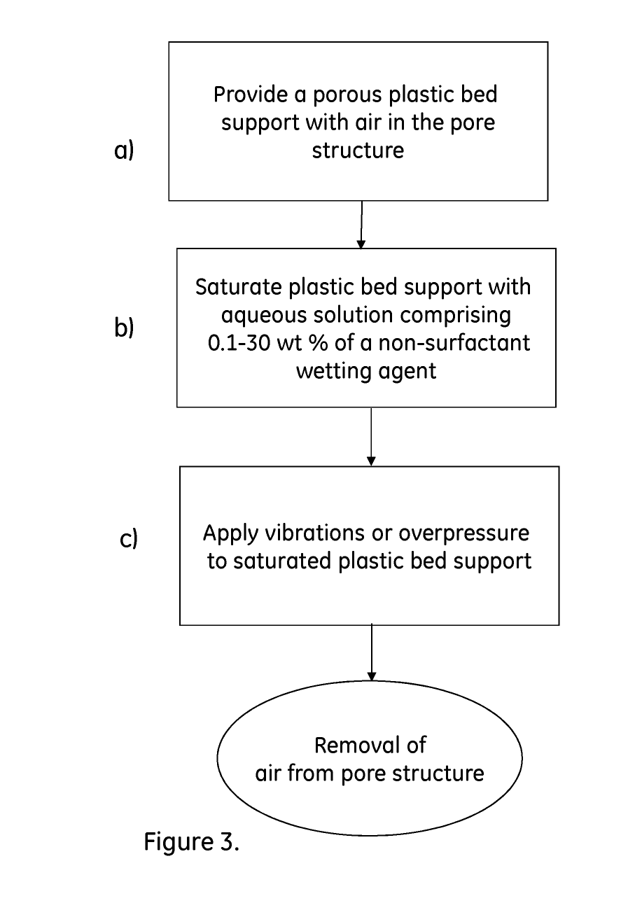

In certain embodiments, illustrated by FIG. 3, the method also comprises a step of applying at least 10 kPa, such as at least 50 kPa or at least 100 kPa, overpressure to said plastic bed support when soaked in said aqueous solution and/or vibrating said plastic bed support when soaked in said aqueous solution. The vibration may be continuous or intermittent and may comprise vibrations of constant or varying frequencies. The application of overpressure can be done to a separate soaking vessel or to a chromatography column comprising the soaked plastic bed support. The overpressure can be applied as one or more pulses of with a release of pressure after each pulse. The pulse length can be up to several hours, such as at least one hour. The treatment may also comprise one or more pulses of reduced pressure, e.g. vacuum.

In certain embodiments the method further comprises a step of mounting the plastic bed support in a chromatography column. This step can be carried out after the soaking of the bed support in the non-surfactant wetting agent solution and the vibration or pressurizing. In this case the bed support can be soaked and vibrated or pressurized in a separate soaking vessel or trough and afterwards mounted in the column. This method is particularly advantageous for smaller bed supports, e.g. of up to 300 mm diameter. Alternatively, the mounting step can also be carried out before the soaking and vibration or pressurizing, in which case the soaking and vibration or pressurizing will take place in the column. The soaking can in this case conveniently be done by partially or completely filling the column with an aqueous solution comprising a non-surfactant wetting agent. Such a method is particularly advantageous for larger bed supports, e.g. of at least 300 mm diameter.

In some embodiments the method also comprises a step of washing the plastic bed support to remove the non-surfactant wetting agent. The washing can be done when the bed support is mounted in the column, e.g. by passing a washing fluid through the column, or alternatively by replacing the wetting agent solution in the soaking vessel or trough with washing fluid. The washing fluid can be an aqueous fluid, such as water or a buffer or salt solution.

In one embodiment the step of vibrating the soaked bed support comprises applying ultrasound to the plastic bed support. The ultrasound can comprise vibrations in the 20-400 kHz frequency range and can be applied e.g. by immersing an ultrasound transducer in the non-surfactant wetting agent solution, by contacting an ultrasound transducer with the walls of the soaking vessel/trough/column or by using an ultrasound bath as the soaking vessel or trough. Ultrasound transducers and baths are well known in the art and are available from many suppliers. An advantage of applying ultrasound is that the penetration of the non-surfactant wetting agent solution into the pore structure of the plastic bed support is improved and the air is dispersed as small bubbles that can easily be removed from the bed support. In a specific embodiment, the frequency and/or the amplitude of the ultrasound is tuned to provide optimal air removal from a particular combination of bed support and soaking vessel/trough.

In certain embodiments the step of vibrating the soaked bed support can also comprise applying vibrations of non-ultrasound frequencies (i.e. outside the 20-400 kHz range) to the plastic bed support. The vibration frequency can be below 20 kHz, such as e.g. in the 25-500 Hz interval where commercial equipment for vibration of e.g. concrete is readily available. Both internal “poker” vibrators and external vibrators mounted on the vessel/trough/column can be used.

In certain embodiments the non-surfactant wetting agent has a molecular weight of less than 130 D, such as less than 110 D or even less than 70 D. It can also have a molecular weight between 50 and 130 D, such as between 50 and 110 D. An advantage of having a low molecular weight is that it is easier to wash out the wetting agent, while it can be advantageous to avoid the lowest molecular weights in order to reduce volatility and flammability.

In some embodiments the non-surfactant wetting agent is selected from the group consisting of alkali metal hydroxides and water soluble C3-C6 alcohols, glycols and glycol ethers, such as water soluble C3-C6 primary alcohols. Suitable alkali metal hydroxides include sodium hydroxide, potassium hydroxide, lithium hydroxide, rubidium hydroxide and cesium hydroxide. Sodium hydroxide and potassium hydroxide are preferred for cost reasons. Alkali metal hydroxides can suitably be applied in concentrations from 0.1-10 wt %, such as 2-8 wt %. It is important to use adequate protection equipment such as protective glasses when working with alkali metal hydroxide solutions. An advantage of alkali metal hydroxides is that they are non-combustible and hence their aqueous solutions do not have a flash point.

Examples of water soluble C3-C6 alcohols are n-propanol, isopropanol, n-butanol, isobutanol, 2-butanol, tert-butanol, pentanols, hexanols and benzyl alcohol, of which n-propanol, n-butanol, n-pentanol, n-hexanol and benzyl alcohol are primary alcohols. N-propanol and isopropanol are completely water-miscible at room temperature. Examples of water soluble (and completely water-miscible) C3-C6 glycols include 1,2-propanediol, 1,2-butanediol, 1,2-pentanediol, 1,2-hexanediol, 1,3-propanediol, 1,4-butanediol, diethylene glycol etc. Examples of water soluble (and completely water-miscible) C3-C6 glycol ethers include ethylene glycol methyl ether, ethylene glycol ethyl ether, ethylene glycol propyl ether, ethylene glycol butyl ether, diethylene glycol methyl ether, diethylene glycol ethyl ether, propylene glycol methyl ether, propylene glycol ethyl ether etc. An advantage of using water soluble C3-C6 alcohols, glycols or glycol ethers is that they are better wetting agents than e.g. ethanol and can hence be used in lower concentrations. At equal concentration their aqueous solutions also have higher flame points than ethanol solutions. In one embodiment the aqueous non-surfactant wetting agent solution comprises 2-30 wt %, such as 10-25%, 12-21% or 12-17% of one or more C3-C6 alcohols, glycols or glycol ethers. One advantage of not exceeding 30% concentration of the alcohols, glycols or glycol ethers is that the flash point of the solution can be kept above the operating temperature. Another advantage is that at these concentrations the solution is less likely to attack sensitive materials in some bioprocess columns, e.g. acrylic column tubes and rubber gaskets. The solution can be homogeneous, i.e. the concentration of the aqueous non-surfactant wetting agent does not exceed its room temperature water solubility. The room temperature water solubility of the aqueous non-surfactant wetting agent can be at least 4 wt %, such as at least 12 wt % or it can be completely water-miscible.

Mixtures of different non-surfactant wetting agents are also considered. They can be mixtures of different alcohols, glycols and glycol ethers, as well as mixtures of one or more of these substances with one or more alkali metal hydroxides. In this case, the total concentration of non-surfactant wetting agents can be 0.1-30 wt %, such as 0.1-20 wt %, 0.1-17 wt % or 12-17 wt %.

In certain embodiments said aqueous solution in step b. has either no flash point or a (closed-cup) flash point of at least about 30° C., such as higher than about 35° C. or about 40° C. This has the advantage that the aqueous solution is not considered flammable under the conditions of use and that consequently it is not necessary to use costly explosion proof equipment and localities. Alkali metal hydroxides are non-combustible and hence their aqueous solutions do not have a flash point. Flash points for aqueous solutions of ethanol, n-propanol and isopropanol are given in Table 1.

TABLE 1
Closed-cup flash points (° C.) for aqueous alcohol solutions of
different concentrations.

| Conc. wt. % | Ethanol | n-propanol | Isopropanol |
|---|---|---|---|
| 12 | 39-40 | 36-37 | 32-33 |
| 17 | 35 | 34 | 29 |
| 21 | 31-32 | 33 | 26-27 |
| 26 | 29 | 28 | 20 |

Isopropanol and particularly n-propanol are more efficient wetting agents than ethanol and can hence be used in lower concentrations, resulting in higher flash points. Due to their higher molecular weights and corresponding lower volatilities, water soluble C4-C6 alcohols, glycols and glycol ethers can generally be expected to have higher flash points in aqueous solution than the C2-C3 alcohols listed in the table.

In one embodiment the non-surfactant wetting agent is selected from the group consisting of n-propanol, sodium hydroxide and potassium hydroxide. In a specific embodiment the aqueous non-surfactant wetting agent solution comprises 12-21 wt %, such as 12-17 wt %, n-propanol.

In certain embodiments the plastic bed support has a diameter of at least 5 cm, such as at least 10 cm or at least 30 cm. Proper removal of air is particularly important for large-diameter process columns and flammability is also a more important issue for large diameter bed supports due to the larger exposed surface and the difficulty of working in ventilated fume hoods etc.

In certain embodiments the plastic bed support comprises a sintered porous plastic. Sintered porous plastics as obtainable from e.g. Porvair PLC (UK) and Porex Corp (US) have suitable pore structures and good mechanical properties for use as chromatography bed supports. The plastic support can comprise a polyolefin, such as polyethylene (high or low density), polyopropylene or ethylene/propylene copolymers. It can also comprise other plastics such as polytetrafluoroethylene or polyethetherketone. Alternatively the plastic bed support can comprise a woven or non-woven fibrous structure, optionally in a multilayer construction. The fibers can be prepared e.g. from polyolefins like polyethylene or polypropylene.

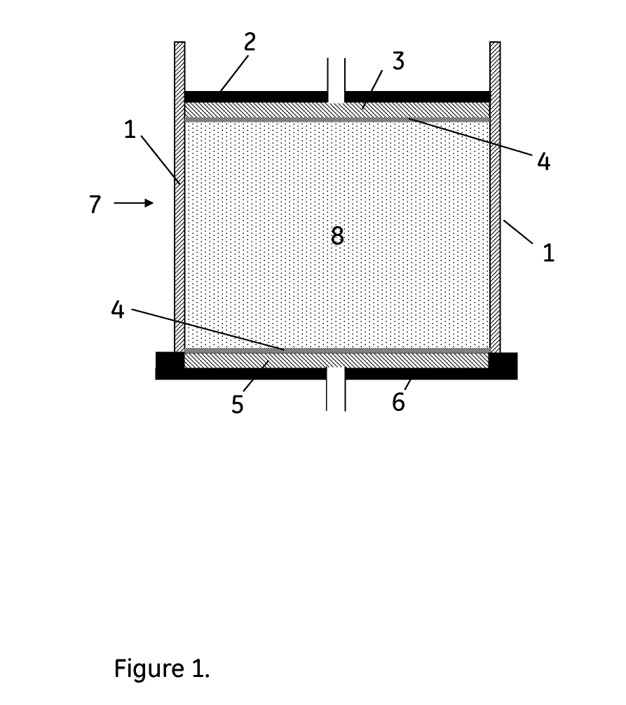

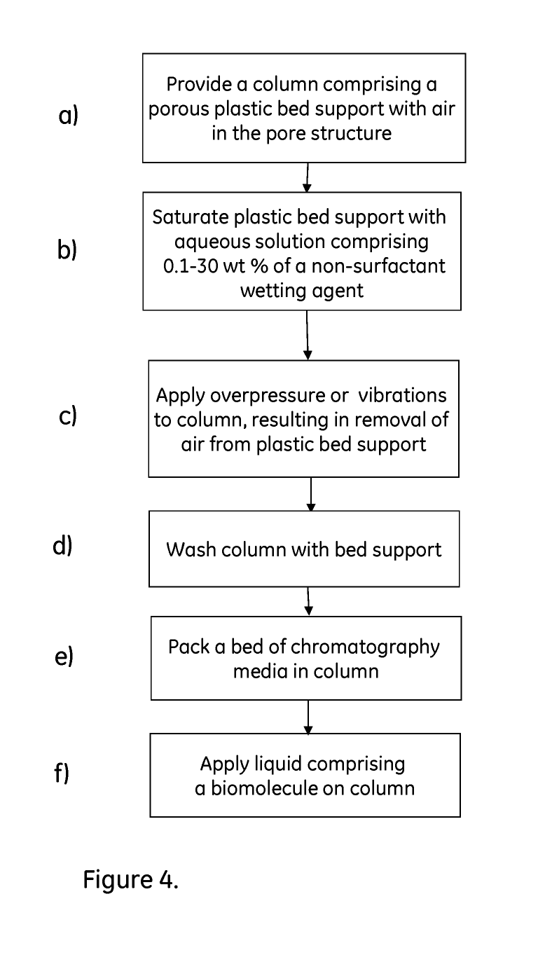

A further aspect of the invention illustrated by FIGS. 1 and 4 relates to performing a chromatographic separation of a biomolecule on a column 7 equipped with at least one plastic bed support 4 from which air has been removed without using surfactants or flammable solutions. This is achieved by a method where a. a column 7 comprising a porous plastic bed support 4 having air in the pore structure is provided, b. the plastic bed support 4 is soaked in an aqueous solution comprising 0.1-30 wt %, such as 0.1-20 wt %, 0.1-17 wt % or 12-17 wt %, of a non-surfactant wetting agent, c. vibrations or at least 10 kPa, such as at least 50 kPa or at least 100 kPa, overpressure are applied to said column when the plastic bed support is soaked in said aqueous solution, resulting in the removal of at least about 60% of the air from said pore structure, d. the plastic bed support is washed, e. a bed 8 of chromatography media is packed in the column and f. a liquid comprising a biomolecule is applied on the column. The column can comprise a column tube 1, an upper end plate 2, an upper distributor plate 3, a lower distributor 5 and a lower end plate 6. The biomolecule can be a nucleic acid, a vaccine or a protein, e.g. an immunoglobulin such as a monoclonal antibody. The liquid can be e.g. a clarified cell culture, blood plasma or an eluate or flow-through from a previous chromatography column.

In certain embodiments at least about 80%, such as at least about 90% or substantially all air is removed from the pore structure.

In one embodiment the aqueous solution in step b has either no flash point or a flash point of at least 30° C., such as higher than 35° C.

According to one embodiment, the aqueous solution in step b comprises 12-21 wt % n-propanol (e.g. 12-17 wt % n-propanol) or 0.1-10 wt % sodium- or potassium hydroxide.

In one embodiment the plastic bed support comprises a sintered porous plastic. The plastic bed support can comprise a polyolefin such as polyethylene.

In one embodiment the plastic bed support has a diameter of at least 10 cm, such as at least 30 cm.

Other features and advantages of the invention will be apparent from the following examples and from the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### EXAMPLES

### Example 1

### Wetting of Separate Polyethylene Frits

100 mm diameter sintered polyethylene (PE) frit disks (Porvair PLC Vyon® F HDPE, thickness 3.2 mm, pore size 20 microns, pore volume 36%) were cut into approx. 8 pieces. Each piece was weighed dry and the dry weight was noted. A drop of each solution was first added to a piece to see the degree of absorption by the sinter. The PE frit pieces were then immersed in the different solutions and weighed at 2, 6, and 24 hours after immersion. The pieces were then placed on a shaker (Edmund Buehler SM) for 30 minutes and finally rinsed with running purified water.

Petri dishes of glass (19.5 cm diameter) were filled with the respective solutions and a piece of frit material was placed into each solution. The frits were more or less floating on the surface of the liquid i.e. they were not totally immersed in the liquid. Intermittently, a plastic pipette was used to press the frits down and slightly knocking on them in the aim to get rid of air. After 1 hour they were turned over and after additional 1 hour the pieces were weighed (a total of 2 hours) and the weights were noted. The pieces were put back into the Petri dishes and turned over after 2 hours. After additional 2 hours the pieces were weighed (a total of 6 hours) and the weights noted. The pieces were again placed in the Petri dishes and allowed to stay overnight. After approximately 24 hours the pieces were weighed and the weights noted. The pieces placed in their solutions were then put on a shaker for 30 min, weighed and the weights noted. Finally, the pieces were rinsed with running water for about 1 minute and 30 seconds. Before the frit pieces were weighed, the edges were quickly wiped with a soft tissue by pressing the edges against a tissue placed on a lab bench.

A piece of PE frit was wetted in an ultrasound bath (Elma S 450H) with 1 M (4 wt %) NaOH for 15 minutes on each side. The piece was then rinsed with running water and quickly wiped with a soft tissue to get rid of drops.

### Example 1a

As can be seen from Table 1, 26 wt % 1-propanol and 26 wt % 2-propanol (IPA) gave the best wetting expressed as solution uptake. This was also observed when a drop of solution was added to the different pieces of PE fits. The drops of 1-propanol and 2-propanol solution were absorbed by the PE frits while drops from the other solutions remained on the frit surface. The weight had increased about 50% after 2 hours for the pieces of PE frits put into these solutions. A piece of PE frit wetted in an ultrasound bath with 1 M (4 wt. %) NaOH was also used. As can be seen from Table 1 this method gave only about 5% increase in weight after 2 hours but additional wetting with an increase in weight to 33% could be seen after rinsing them with running purified water. 8 M Urea gave the smallest increase in weight with about 4% after 2 hours. The other solutions gave increase in weights between 4-30%.

The time did not seem to have any effect on the wetting because the weight did not increase much after 2 hours maybe a slightly increase in weight was observed after 6 hours for 17 wt % ethanol but no additional uptake of solution was observed after additional 18 hours e.g. after a total of 24 hours. However, increase in weights were noticed for some solutions after rinsing them with water, see Table 1.

TABLE 2
Screening test showing the frit weight increase (%) after 2-24 hours
immersion in the different solutions

| | | | | Wt |
|---|---|---|---|---|
| | 2 h wt | 6 h wt | 24 h wt | increase |
| | increase, | increase, | increase, | after water |
| Test solution | % | % | % | rinse, % |
| 26 wt % 1-propanol | 51 | 51 | 50 | 49 |
| 26 wt 2-propanol (IPA) | 50 | 51 | 51 | 49 |
| 1 + 1 (26 wt % 2- | 45 | 45 | 46 | 46 |
| propanol (IPA) + 1M | | | | |
| NaOH) | | | | |
| 4 wt % Benzyl alcohol | 36 | 38 | 38 | 40 |
| 17 wt % Ethanol | 9 | 12 | 12 | 18 |
| 300 ppm sodium | 5 | 6 | 5 | 14 |
| hypochlorite in 1M | | | | |
| NaOH | | | | |
| 1M NaOH | 5 | 6 | 6 | 23 |
| 1M NaOH in an | 5 | — | — | 33 |
| ultrasound bath after | | | | |
| rinsing with water | | | | |
| 8M Urea | 3 | 4 | 4 | 5 |

To correct for the different densities of the solutions a calculation of the absorbed volume per gram frit material was done. The calculations are documented in Table 3. From the pore volume (36%) and the HDPE material density (0.95 g/ml) of the frit material used, the volume uptake corresponding to complete displacement of all air can be calculated to be 0.59 ml/g.

TABLE 3
Absorbed volume per gram PE frit material.

| | Volume uptake, ml (after 2 hours) |
|---|---|
| | for 1 gram of PE frit material |
| Solution | ml/g |
| 26 wt % 1-propanol | 0.53 |
| 26 wt % 2-propanol | 0.52 |
| 1 + 1 (26 wt % 2-propanol (IPA) + | 0.45 |
| 1M NaOH) | |
| 4 wt % benzyl alcohol | 0.36 |
| 17 wt % ethanol | 0.09 |
| 300 ppm sodium hypochlorite in 1M | 0.05 |
| NaOH | |
| 1M NaOH | 0.05 |
| 1M NaOH in an ultrasound bath | 0.05 |
| 8M Urea | 0.03 |

### Example 1b

Table 3 shows results for the different concentrations performed with 1-propanol and 2-propanol. 1-propanol seems to have better effect of wetting the pieces of PE frit. 17 wt % 1-propanol gave 53% increase in weight while 2-propanol only gave 29% after 2 hours. For 2-propanol 21 wt % was required to achieve the same effect. For the lower concentrations 8 and 12% an increase in weight could be seen after 24 hours and after rinsing with water. The same effect applies to 17 wt % 2-propanol.

TABLE 4
Results shown with increase in weight for different concentrations of
2-propanol and 1-propanol

| | 1-propanol | | Wt increase | 2-propanol | | Wt increase |
|---|---|---|---|---|---|---|
| Conc. | 2 h wt | 24 h wt | after water | 2 h wt | 24 h wt | after water |
| wt % | increase, % | increase, % | rinse, % | increase, % | increase, % | rinse, % |
| 8 | 6 | 18 | 29 | 6 | 10 | 21 |
| 12 | 34 | 40 | 44 | 15 | 23 | 33 |
| 17 | 53 | 51 | 50 | 29 | 37 | 43 |
| 21 | — | — | — | 50 | 52 | 51 |
| 26 | 51 | 50 | 49 | 51 | 50 | 49 |

### Example 2

### Wetting of Polyethylene Bed Support Mounted in a Column

A dry disk of Porvair PLC Vyon® F sintered PE—thickness 3.2 mm, pore size 20 microns—was immersed in 1 M NaOH, treated in an ultrasonic bath for 2*15 min and then washed with 17 wt % aqueous ethanol before mounting in a 300 mm column.

Another dry disk of Porvair PLC Vyon® F sintered PE—thickness 3.2 mm, pore size 20 microns was directly mounted in the 300 mm column, which was filled with 17 wt % aqueous 1-propanol, pressurized to 100 kPa overpressure and incubated for 2 hours.

In both cases the columns were packed to 10 cm bed height with SP Sepharose® HP cation exchange media (GE Healthcare Life Sciences) and then unpacked and repacked twice with the same media. After each packing, the plate number (N/m—plates per m) and the asymmetry factor were measured by standard methods known in the art. The results summarized in Table 3 show that acceptable plate numbers were achieved and that the experiment using wetting with 17 wt % 1-propanol in situ in the columns gave a better consistency between the packings, indicating a more complete wetting from the start. Comparative experiments where the bed support was only contacted with water gave unsatisfactory column performance.

TABLE 5
Plate number and asymmetry factor for packed columns

| | | Plate | |
|---|---|---|---|
| Wetting method | Packing no. | number N/m | Asymmetry As |
| Loose support in 1M | 1 | 13842 | 1.03 |
| NaOH + ultrasound | 2 | 18072 | 1.16 |
| | 3 | 18725 | 1.15 |
| | % increase from | 35 | 12 |
| | packing 1 to | | |
| | packing 3 | | |
| Support in column | 1 | 18295 | 1.11 |
| with 17% 1-propanol | 2 | 18901 | 1.15 |
| | 3 | 19345 | 1.17 |
| | % increase from | 6 | 5 |
| | packing 1 to | | |
| | packing 3 | | |

All patents, patent publications, and other published references mentioned herein are hereby incorporated by reference in their entireties as if each had been individually and specifically incorporated by reference herein. While preferred illustrative embodiments of the present invention are described, one skilled in the art will appreciate that the present invention can be practiced by other than the described embodiments, which are presented for purposes of illustration only and not by way of limitation. The present invention is limited only by the claims that follow. It is pointed out that any feature described in relation to one embodiment may be used also in combination with one or more features of any other of the embodiments described.

1. A method for wetting a plastic bed support for a chromatography column, said method comprising the steps of:
a. providing a plastic bed support with a pore structure comprising air in said pore structure; and
b. soaking the plastic bed support in an aqueous solution comprising 0.1-30 wt % of a non-surfactant wetting agent, resulting in the removal of at least about 60% of the air from said pore structure.

2. The method of claim 1, further comprising:
c. applying at least 10 kPa overpressure to said plastic bed support when soaked in said aqueous solution and/or vibrating said plastic bed support when soaked in said aqueous solution.

3. The method of claim 1 wherein step b comprises soaking the plastic bed support in an aqueous solution comprising 0.1-17 wt %, such as 12-17 wt %, of a non-surfactant wetting agent.

4. The method of claim 1, further comprising:
d. washing said plastic bed support to remove said non-surfactant wetting agent.

5. The method of claim 2, wherein step c. comprises applying ultrasound to the plastic bed support.

6. The method of claim 1, wherein in step b. said aqueous solution has either no flash point or a flash point of at least about 30° C., such as higher than about 35° C.

7. The method of claim 1, wherein said non-surfactant wetting agent is selected from the group consisting of alkali metal hydroxides and water soluble C3-C6 alcohols, glycols and glycol ethers, such as water soluble C3-C6 primary alcohols.

8. The method of claim 1, wherein said non-surfactant wetting agent is selected from the group consisting of n-propanol, sodium hydroxide and potassium hydroxide.

9. The method of claim 1, wherein said aqueous solution comprises 12-21 wt % n-propanol, such as 12-17 wt %.

10. The method of claim 1, wherein said plastic bed support has a diameter of at least 5 cm, such as at least 30 cm.

11. The method of claim 1, wherein said plastic bed support comprises a sintered porous plastic.

12. The method of claim 1, wherein said plastic support comprises a polyolefin such as polyethylene.

13. A method for separation of a biomolecule on a column (7) comprising at least one plastic bed support (4), said method comprising the steps of:
a. providing a column (7) comprising a plastic bed support (4) with a pore structure comprising air in said pore structure;
b. soaking said plastic bed support in an aqueous solution comprising 0.1-30 wt % of a non-surfactant wetting agent;
c. applying at least 10 kPa overpressure to said column when the plastic bed support is soaked in said aqueous solution and/or vibrating said column when the plastic bed support is soaked in said aqueous solution, resulting in the removal of at least about 60% of the air from said pore structure;
d. washing said plastic bed support;
e. packing a bed (8) of chromatography media in said columns; and
f. applying a liquid comprising a biomolecule on said column.

14. The method of claim 13, wherein in step b said aqueous solution has either no flash point or a flash point of at least 30° C., such as higher than 35° C.

15. The method of claim 13, wherein in step b said aqueous solution comprises 12-21 wt %, such as 12-17 wt %, n-propanol or 0.1-10 wt % sodium- or potassium hydroxide.

16. The method of claim 13, wherein said plastic bed support comprises a sintered porous plastic.

17. The method of claim 13, wherein said plastic support comprises a polyolefin such as polyethylene.

18. The method of claim 13, wherein said plastic bed support has a diameter of at least 5 cm, such as at least 30 cm.
